(19) United States
(12) Patent Application Publication
(10) Pub. No.: US 2026/0223836 A1
(43) Pub. Date: Aug. 6, 2026

(54) MULTI-FUNCTIONAL LIVING TISSUE TRANSPORTER CASE

(71) Applicants: Paul W. Waltzing, San Gwann (MT); Diego Balarezo, Quito (EC)

(72) Inventors: Paul W. Waltzing, San Gwann (MT); Diego Balarezo, Quito (EC)

(21) Appl. No.: 19/044,784

(22) Filed: Feb. 4, 2025

(51) Int. Cl. A01N 1/145; A01N 1/148

(52) U.S. Cl. CPC A01N 1/145; A01N 1/148

(57) ABSTRACT

A transportation container system for living tissue includes a cryocooler that provides chilled cooling fluid, typically air preferably with added oxygen, using a piston-driven Stirling engine. The chilled cooling fluid is distributed near the living tissue by a network of electronically-controlled valves. The transportation container system for living tissue further includes a high-conductivity inner wall, temperature sensors on the cooling platform, and an electronic control system that monitors temperature and enables enhanced remote and transporter control of the temperature and the composition of the physical environment surrounding the living tissue.

### TECHNICAL FIELD

In the field of containers for organs and other living tissue, an apparatus used for the transportation and preservation of living parts employing refrigeration and humidity control.

### BACKGROUND ART

Living tissue transporters are specialized devices or systems designed to transport living cells, tissues, or organs without causing damage or compromising their viability. Transporters are often critically important in medical and research settings, where the safe and efficient transfer of biological materials is essential.

Transporting organs for transplant is a highly coordinated and time-sensitive process. Organs are often preserved using special solutions and kept refrigerated to maximally extend their viability. For example, hearts and lungs typically remain viable for 4-6 hours, while kidneys typically last 24-36 hours.

To promote efficient transportation each organ is packaged to ensure it remains in optimal condition during transport. This includes using sterile containers, refrigeration and in containers often considered preservation machines.

Depending on the distance and urgency, organs are often transported via ambulances, helicopters, or airplanes. The transportation process requires seamless coordination between the donor hospital, organ procurement organization, and the recipient's transplant team.

While the container is important, transportation can be subject to the vagaries of weather delays, cargo handling issues, and regulatory requirements. In all cases, organs are carefully tracked and documented throughout the transportation process to provide maximum confidence that they reach their destination safely and on time.

### SUMMARY OF INVENTION

A transportation container system for living tissue includes a cryocooler that provides chilled cooling fluid, typically air and/or oxygen, using a piston-driven Stirling engine. The chilled cooling fluid is distributed near the living tissue by a network of electronically-controlled valves. The transportation container system for living tissue further includes a high-conductivity inner wall, temperature sensors on the cooling platform, and an electronic control system that monitors temperature and enables enhanced transporter control of the temperature and gaseous atmosphere surrounding the living tissue. The cryocooler, the electronically-controlled valves, and the network of thermally conductive conduits are preferably removable to facilitate cleaning, assembly and disassembly.

The Stirling engine is configured for compression and expansion of a working fluid, typically helium, to provide the cooling fluid at a user-designated temperature. The cryocooler is configured with a network of thermally conductive conduits that permit distribution of the cooling fluid within the transportation container system to locations surrounding the living tissue.

The electronically-controlled valves are configured to dynamically open or close to provide the cooling fluid at a uniform temperature surrounding the living tissue. The high-conductivity inner wall within the transportation container system is made with a high-thermal-conductivity material, typically stainless steel, protected by insulation under the high-thermal-conductivity material.

The temperature sensors are located on the inner wall and are configured to indicate an average temperature surrounding the living tissue and further configured to permit a transporter to monitor thermal conditions within the transportation container.

The electronic control system automatically adjusts the temperature of the cooling fluid released by the electronically-controlled valves. The electronic control system displays the average temperature indicated by the plurality of temperature sensors and enables a transporter to set the temperature of the cooling fluid surrounding the living tissue.

The transportation container system utilizes a vacuum seal to protect the living tissue, which by example may be one or more of blood, a heart, a liver, a kidney, a vein, a gland, a muscle, a pancreas, a lung, an intestine, bone marrow, a bone, cartilage, connective tissue, and skin.

The transportation container system may have either a removable lid or a hinged lid and is preferably equipped with a transparent observation port that enables a transporter to view the living tissue without opening the transportation container.

### Technical Problem

Real-time monitoring during transport of living tissue is needed. Living tissue includes, but is not limited to: blood, a heart, a liver, a kidney, a vein, a gland, a muscle, a pancreas, a lung, an intestine, bone marrow, a bone, cartilage, connective tissue, and skin and other organs or body parts.

A temperature control system for the transportation container is needed that can enables precise temperature regulation in every area of the container, especially the area surrounding the living tissue.

The temperature control system is needed that enables comprehensive temperature/data monitoring and control system that enables remote real-time oversight, allowing healthcare professionals to make immediate adjustments from a remote location, when necessary.

### Solution to Problem

The solution to the problem is a modular storage and transportation container that is designed to accommodate various organ types and sizes and prioritize organ safety during transit. The device enables autonomous operation with a reliable power source, suitable for a range of transportation scenarios.

The solution to the problem is a transportation container system that incorporates a 360-degree electronic temperature control system, enabling direct and remote regulation of the temperature surrounding the living tissue.

### Advantageous Effects of Invention

The invention enables precise temperature control surrounding the living tissue within the transportation container system.

The invention enables real-time monitoring and control of the environmental constituents surrounding the living tissue during transportation.

The incorporation of a 360-degree electronic temperature control system, cryogenic technology, oxygen regulation, a carefully engineered base, a backup lithium battery and GPS monitoring demonstrates the device's commitment to maintaining optimal conditions for organ preservation during transit.

The transportation container system is designed with modularity in mind. It accommodates various organ types and sizes, along with grafts. This provides a secure and ergonomic solution for transportation. The container's design minimizes the risk of physical trauma to the organ during transit.

The transportation container system operates autonomously with a reliable lithium battery-powered source, making it suitable for various transportation scenarios, including long-distance organ deliveries.

The transportation container system is equipped with GPS for real-time tracking.

After an organ is placed within the transportation container system. The system is activated, initiating the cooling process and data monitoring. During transportation, the transportation container system ensures that the living tissue remains at the desired temperature, thus preserving its quality. Collected data is made available in real-time to authorized healthcare personnel for direct and remote oversight.

### BRIEF DESCRIPTION OF DRAWINGS

The drawings illustrate preferred embodiments of a method of using a medical device according to the disclosure. The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is an exploded perspective view of the transportation container system with a removable top.

FIG. 2 is a front elevation view of the transportation container system with a hinged top.

FIG. 3 is side elevation view showing inner components within the transportation container system.

FIG. 4 show left-side and right-side views of the network of thermally conductive conduits along with the electronically controlled valves within the transportation container system.

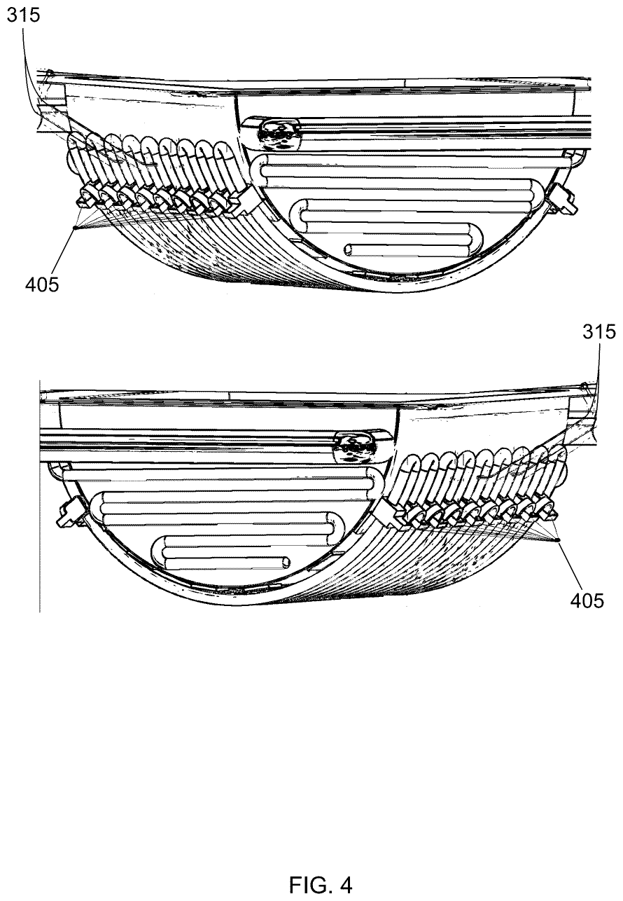

FIG. 5 is a front elevation view of the transportation container system showing the hinged top with a viewing port and a control panel for the user-designated temperature setting.

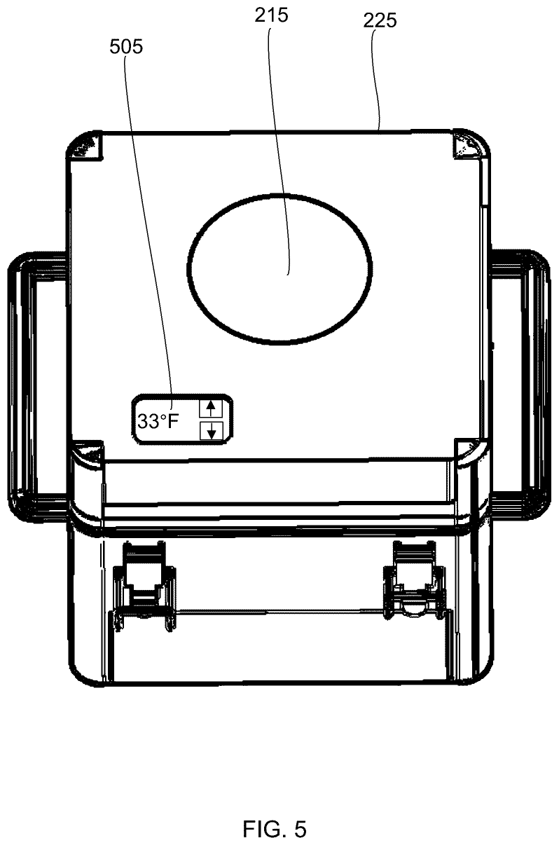

FIG. 6 shows two top perspective views of the network of thermally conductive conduits, the temperature sensors, and a liver in a transit position atop the conduits and temperature sensors.

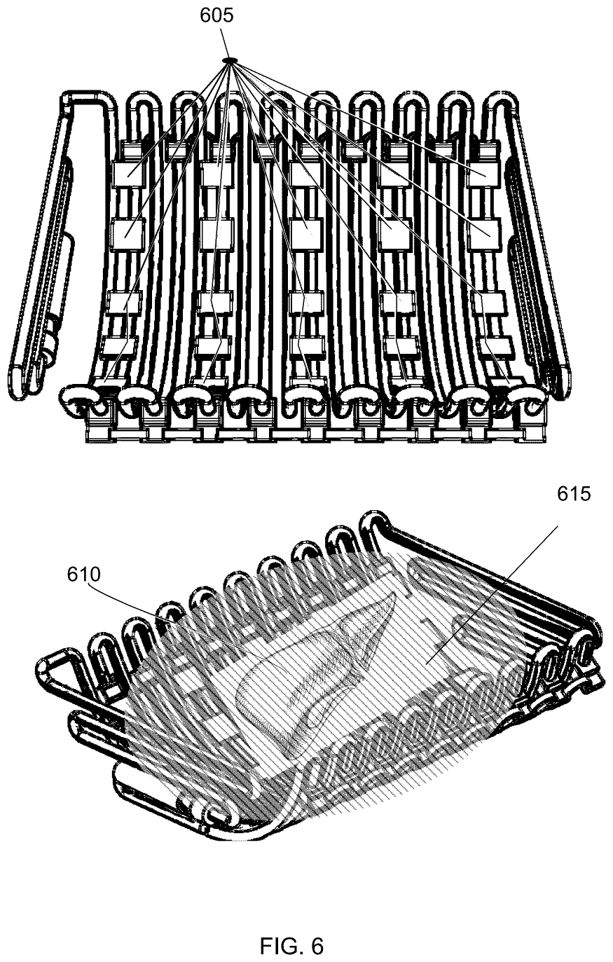

FIG. 7 shows a hypothetical transporter of the transportation container system and stainless steel used for the inner wall of the transportation container system.

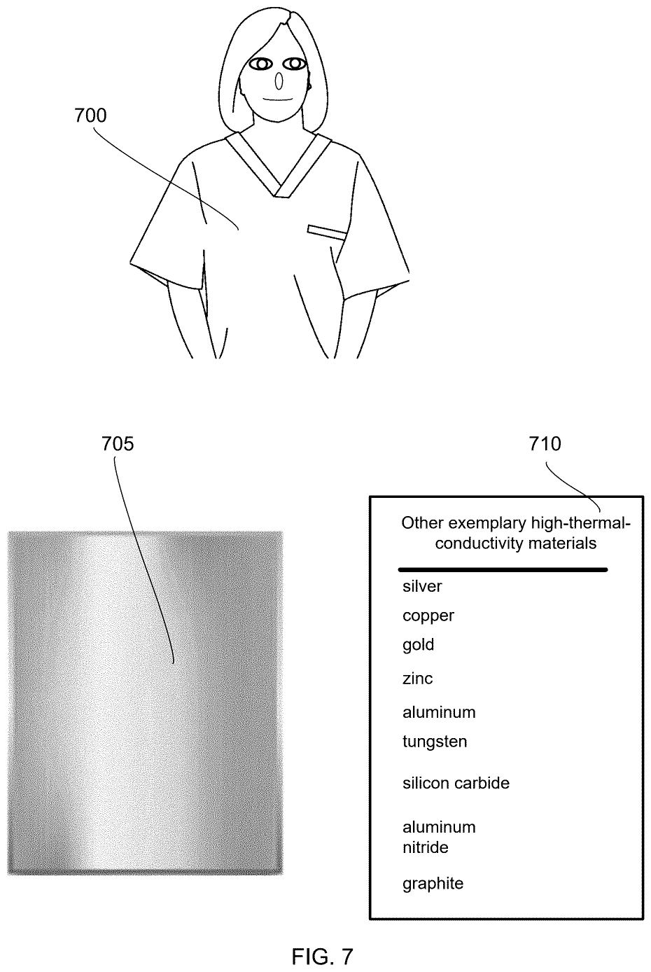

FIG. 8 illustrates a remote computer monitor and control of the transportation container system.

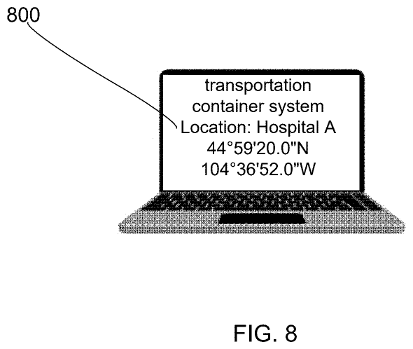

### DESCRIPTION OF EMBODIMENTS

In the following description, reference is made to the accompanying drawings, which form a part hereof and which illustrate the transportation container system (100). The drawings and the preferred embodiments of the invention are presented with the understanding that the the transportation container system (100) is susceptible of embodiments in many different forms and, therefore, other embodiments may be utilized and structural, and operational changes may be made, without departing from the scope of the transportation container system (100) disclosed.

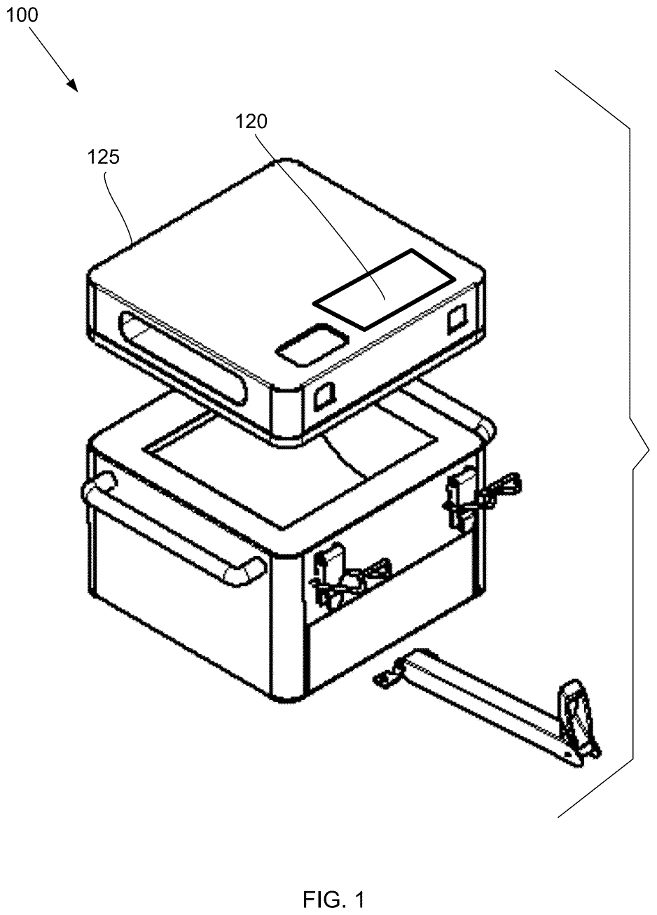

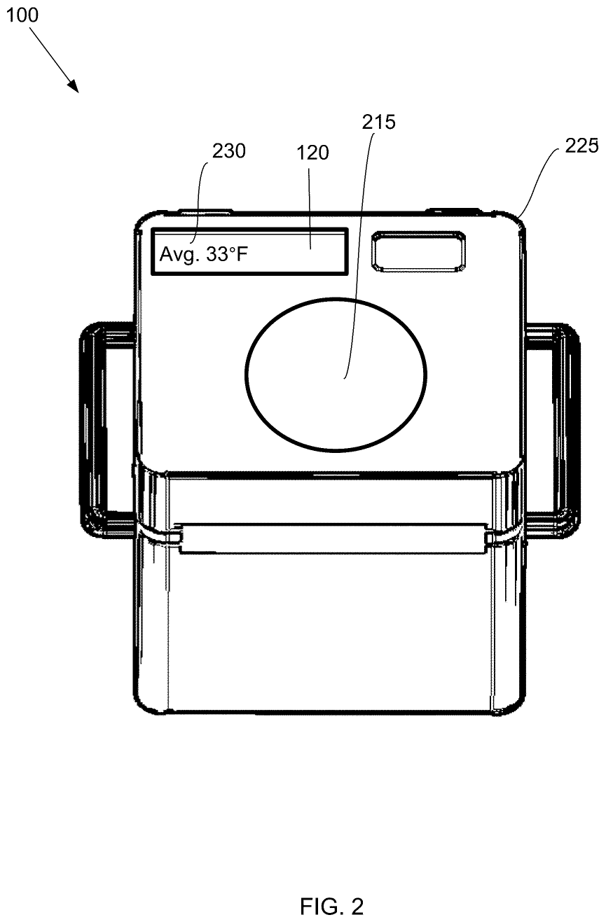

A transportation container system (100) for living tissue (610) is shown in FIGS. 1 and 2. In FIG. 1, the transportation container system (100) has a removable lid (125) and in FIG. 2, the transportation container system (100) has a hinged lid (225).

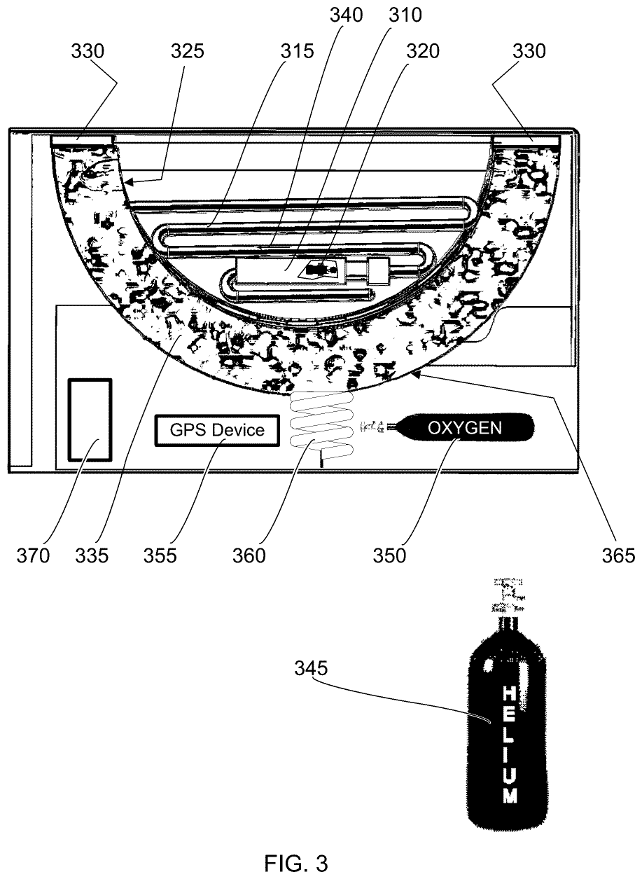

The transportation container system includes a cryocooler (310) with a piston-driven Stirling engine (320), shown using a cut-out through a side-wall of the cryocooler (310) in FIG. 3.

The cryocooler (310) is configured with a network of thermally conductive conduits (315), which is further configured to distribute cooling fluid (340), signified by the arrow within the network of thermally conductive conduits (315) in FIG. 3.

The cooling fluid (340) is preferably air with added oxygen (350), but may also be any of: water (purified or deionized), ethylene glycol, propylene glycol, tissue fluid, mineral oil, and dielectric fluid, depending on compatibility with the living tissue (610) being transported. While cryogenic temperatures are possible, an exemplary transportation temperature range is 32.1 to 35 degrees Fahrenheit.

The network of thermally conductive conduits (315) distributes the cooling fluid (340) for release within the transportation container system (100) at electronically-controlled valves (405). The piston-driven Stirling engine (320) is configured for compression and expansion of a working fluid to provide cooling to a user-designated temperature setting (505).

The transportation container system (100) further includes a spring (360) supporting a base (365) below the insulation layer (335). The spring (360) is configured to provide a cushioning effect for the living tissue (610) while travelling over various surfaces. The spring is preferably configured for dampening vibrations during transport. The spring (360) contributes to the overall stability and safety of living tissue (610) during transportation.

The transportation container system (100) further includes a plurality of electronically-controlled valves (405) configured to dynamically open or close to provide a uniform temperature surrounding the living tissue (610) being transported;

The transportation container system (100) further includes an inner wall (325) within the transportation container system (100) comprising a high-thermal-conductivity material (710).

The transportation container system (100) further includes a plurality of temperature sensors (605) on the inner wall (325) of the transportation container system (100). The plurality of temperature sensors (605) is configured to indicate a temperature surrounding the living tissue (610) to permit a transporter (700) to monitor thermal conditions within the transportation container system (100).

The transportation container system (100) further includes an electronic control system (120) configured to automatically adjust an output of the cooling fluid (340) using the plurality of electronically-controlled valves (405).

The electronic control system (120) includes an advanced system for energy management and monitoring during transportation. The transportation container system (100) incorporates a backup system powered by a battery (370), preferably a lithium battery, which is configured to ensure continuous operation in case of power interruptions. This feature adds an extra layer of reliability to the process, safeguarding the integrity of transported organs. Moreover, the transportation container system (100) is designed with an energy-efficient isolation system or insulation layer (335) that optimizes power consumption throughout the transportation process. The insulation layer (335) thermally isolates the central cavity from the ingress of heat and ensures that the temperature of the physical environment (615) or fluid surrounding the living tissue (610) remains constant and protected from changes due to external factors. Temperature maintenance is a priority for the transportation container system (100). The transportation container system (100) minimizes energy waste, making the transportation process not only reliable but also environmentally conscious.

The transportation container system (100) further includes an advanced system for energy management and monitoring during transportation. The transporter incorporates a backup system powered by lithium batteries, ensuring continuous operation in case of power interruptions. This feature adds an extra layer of reliability to the process, safeguarding the integrity of transported organs. Moreover, the transporter is designed with an energy-efficient isolation system, optimizing power consumption throughout the journey. This system minimizes energy wastage, making the transportation process not only reliable but also environmentally conscious.

The electronic control system (120) is further configured to display an average temperature (230) indicated by the plurality of temperature sensors (605), further configured to enable a user-designated temperature setting (505) of the cooling fluid (340) surrounding the living tissue, and further configured to control a physical environment (615) near the living tissue (610).

The transportation container system (100) further includes a vacuum seal (330). The vacuum seal (330) is an airtight seal between the inside of the transportation container system (100) including any living tissue (610) therein and the environment outside the transportation container system (100). It is created by removing air from a compartment immediately below the removable lid (125) or the hinged lid (225) of the transportation container system (100), thereby sealing the lid closed. Preferably, removal of air is done using a combination of suction and heat.

The transportation container system, wherein the thigh-thermal-conductivity material of the inner wall (325) comprises stainless steel (705). Other exemplary high-thermal-conductivity materials (710) are silver, copper, gold, aluminum nitride, silicon carbide aluminum, tungsten, graphite, and zinc.

The transportation container system (100), wherein the cooling fluid (340) of the cryocooler (310) is air preferably with added oxygen (350).

The transportation container system (100) may further include living tissue (610) that is a body part selected from the group consisting of blood, a heart, a liver, a kidney, a vein, a gland, a muscle, a pancreas, a lung, an intestine, bone marrow, a bone, cartilage, connective tissue, and skin.

The transportation container system (100), further includes a removable lid and may be equipped with a hinged lid (225).

The transportation container system (100) preferably includes a working fluid in the piston-driven Stirling engine (320) that comprises helium (345).

The transportation container system (100), wherein the inner wall (325) within the transportation container system (100) further comprises an insulation layer (335). The insulation layer (335) is preferably below and adjacent to the high-thermal-conductivity material (710). The transportation container system (100) features multi-layered thermal barriers made of high-performance materials (e.g., aluminized Mylar or aerogels) to minimize heat exchange and maintain the target temperature within the transportation container system (100).

The transportation container system (100) preferably includes a transparent observation port (215) configured to permit a transporter (700) of the transportation container system (100) to view the living tissue (610) without opening the transportation container system (100).

The transportation container system (100), wherein the cryocooler (310), the electronically-controlled valves (405), and the network of thermally conductive conduits (315) are configured to be removable from the inside of the transportation container system (100) to enable cleaning, assembly and disassembly.

The transportation container system (100), preferably includes a GPS device (355), that is a Global Positioning System device. The GPS device (355) is configured to receive and send navigation signals and use them to report on a location (800) of the transportation container system (100). This GPS device is configured for real-time monitoring of the location of the living tissue (610), by on-site personnel accompanying the transportation container system (100) and remotely by personnel at a dispatch center and a destination medical center.

The transportation container system (100) is configured to implement a secure data connection to ensure that the transportation progress is accurately tracked, which enables swift responses to unforeseen circumstances and which enhances operational efficiency.

The above-described embodiments including the drawings are examples of the invention and merely provide illustrations of the transportation container system. Other embodiments will be obvious to those skilled in the art. Thus, the scope of the transportation container system is determined by the appended claims and their legal equivalents rather than by the examples given.

### INDUSTRIAL APPLICABILITY

The invention has application to the medical industry.

What is claimed is:

1. A transportation container system for living tissue, the transportation container system comprising:
a cryocooler with a piston-driven Stirling engine, the cryocooler is configured with a network of thermally conductive conduits configured to distribute a cooling fluid for release within the transportation container system at electronically-controlled valves, the piston-driven Stirling engine configured for compression and expansion of a working fluid to provide cooling to a user-designated temperature setting;
a plurality of electronically-controlled valves configured to dynamically open or close to provide the cooling fluid at a uniform temperature surrounding the living tissue;
an inner wall within the transportation container system comprising a high-thermal-conductivity material;
a plurality of temperature sensors on the inner wall of the transportation container system configured to indicate an average temperature surrounding the living tissue and further configured to permit a transporter to monitor thermal conditions within the transportation container system; and
an electronic control system configured to automatically adjust the cooling fluid using the plurality of electronically-controlled valves, further configured to display the average temperature indicated by the plurality of temperature sensors, further configured to enable a user-designated temperature setting for the cooling fluid surrounding the living tissue, and further configured to control a physical environment near the living tissue.

2. The transportation container system of claim 1, further comprising a vacuum seal.

3. The transportation container system of claim 1, wherein the high-thermal-conductivity material comprises stainless steel.

4. The transportation container system of claim 1, wherein the cooling fluid is selected from the group consisting of air and oxygen.

5. The transportation container system of claim 1, wherein the living tissue is a body part selected from the group consisting of blood, a heart, a liver, a kidney, a vein, a gland, a muscle, a pancreas, a lung, an intestine, bone marrow, a bone, cartilage, connective tissue, and skin.

6. The transportation container system of claim 1, comprising a removable lid.

7. The transportation container system of claim 1, comprising a hinged lid.

8. The transportation container system of claim 1, wherein the working fluid in the piston-driven Stirling engine comprises helium.

9. The transportation container system of claim 1, further comprising an insulation layer immediately adjacent to the high-thermal-conductivity material.

10. The transportation container system of claim 9, further comprising a spring supporting a base below the insulation layer, the spring configured for dampening vibrations during transport.

11. The transportation container system of claim 1, further comprising a transparent observation port configured to permit a user of the transportation container system to view the living tissue without opening the transportation container system.

12. The transportation container system of claim 1, wherein the cryocooler, the electronically-controlled valves, and the network of thermally conductive conduits are configured to be removable from the inside of the transportation container system.

13. The transportation container system of claim 1, further comprising a Global Positioning System device configured to receive and send navigation signals and use them to report on a location of the transportation container system.
